(19) United States
(12) Patent Application Publication
(10) Pub. No.: US 2012/0182668 A1
(43) Pub. Date: Jul. 19, 2012

(54) SOLID ELECTROLYTIC CAPACITOR AND MANUFACTURING METHOD THEREOF

(75) Inventors: Jae Kwang KIM, Gyeonggi-do (KR); Jun Suk Jung, Gyeonggi-do (KR); Chang Sub Song, Gyeonggi-do (KR)

(73) Assignee: SAMSUNG ELECTRO-MECHANICS CO., LTD., Suwon (KR)

(21) Appl. No.: 13/351,941

(22) Filed: Jan. 17, 2012

(30) Foreign Application Priority Data
Jan. 18, 2011 (KR) 10-2011-0005001

(51) Int. Cl. H01G 9/08; C25D 5/02; H01G 9/15

(52) U.S. Cl. 361/535; 427/80; 216/13; 205/122

(57) ABSTRACT

A solid electrolytic capacitor and manufacturing method, in which an oxidation-resistant coating layer configured to surround the surface of a terminal reinforcing material underlies a capacitor element. The solid electrolytic capacitor includes a capacitor element having a positive polarity internally and having one end to which an anode wire is inserted; a cathode leading-out layer; a pair of terminal reinforcing materials coupled with both bottom sides of the capacitor element; an oxidation resistant coating layer surrounding the surface of the pair of terminal reinforcing materials; a mold part surrounding the outer periphery of the capacitor element, while exposing the other end of the anode wire, the other side of the cathode leading-out layer, and the lower surfaces of the pair of terminal reinforcing materials; and anode and cathode terminals formed on both sides of the mold part and the lower surfaces of the terminal reinforcing materials.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0005001, entitled filed Jan. 18, 2011, which is hereby incorporated by reference in its entirety into this application.”

### BACKGROUND OF THE INVENTION

1. Field of the Invention

The present invention relates to a solid electrolytic capacitor and a manufacturing method thereof, in which an oxidation-resistant coating layer underlies a capacitor element to prevent a terminal reinforcing material from being oxidized.

2. Description of the Related Art

In general, a solid electrolytic capacitor is one of parts which serve to store an electric energy, and cutoff a direct current while passing an alternating current. Among such a solid electrolytic capacitor, a tantalum capacitor has been mainly manufactured.

The tantalum capacitor is used for an application circuit having a narrow range of use of rated voltage, including for general industrial facilities. Particularly, the tantalum capacitor is frequently used to reduce noises on a circuit having a poor frequency property or a portable communication device.

The solid electrolytic capacitor is generally manufactured by inserting a lead wire into the center of a capacitor element made of a tantalum, or a portion except the center thereof. Alternatively, the tantalum capacitor is manufactured by bending the inserted lead wire at outside the capacitor element.

As a method of assembling the lead wire into the capacitor element, there is a method which performs a spot welding on an anode lead terminal and a cathode lead terminal to draw an anode terminal, followed by performs a mold packaging on as-welded terminal, followed by forms an anode lead and a cathode lead, and finally draws an electrode terminal.

FIGS. 1 and 2 are a perspective view and a sectional view of a solid electrolytic capacitor according to the related art, respectively.

As shown in FIGS. 1 and 2, a solid electrolytic capacitor 10 according to the related art includes a capacitor element 11 made of a dielectric power material which is configured to determine a capacity and property of the capacitor, an anode and a cathode frames 13 and 14 which are coupled to the capacitor element 11 so as to be easily connected with a printed circuit board (PCB), and an epoxy case 15 molded with an epoxy which is configured to protect the capacitor element 11 from exterior environments and also make the shape of the capacitor element 11.

A rod-shaped anode wire 12 is protruded from one side of the capacitor element 11 by a constant length.

And, a hole surface 12a having a planar outer surface is formed on the anode wire 12. The hole surface 12a serves to increase a contact region between the anode wire 12 and the anode lead frame 13 and also prevent the anode wire 12 from being swung to right and left during welding.

The capacitor element 11 is manufactured by forming the dielectric power in a rectangular parallelepiped shape using a press process, followed by forming a dielectric oxide layer on the outer surface of the so-formed power using a chemical conversion process, followed by impregnating the same in an aqueous manganese nitrate solution, followed by thermal-decomposing a manganese dioxide layer made of a solid electrolyte, and followed by forming the thermally-decomposed manganese dioxide layer on the outer surface. A connection of the anode and cathode lead frames 13 and 14 to the capacitor element 11 manufactured as described above is implemented by welding the anode lead frame 13 on the hole surface 12a of the anode wire 12, which is protruded from the one side of the capacitor element 11 by a constant distance, to draw an anode terminal, and drawing a cathode terminal using a conductive bonding adhesive coated on the outer surface of the capacitor element 11 and the cathode lead frame 14.

Further, the capacitor element 11, which is electrically connected with the anode lead frame 13 and the cathode lead frame 14, is subject to an exterior process where the epoxy case 15 is formed by molding the capacitor element 11 with an epoxy. Subsequently, a marking work is performed on the epoxy case 15 as formed.

The solid electrolytic capacitor 10 manufactured by the processes as described above has a significantly low volumetric efficiency with respect to the total volume including the epoxy case 15. This causes a low electrostatic capacitance and a high impedance.

In addition, the solid electrolytic capacitor 10 according to the related art generates a high temperature of heat during a process of directly welding the anode wire 12 and the anode lead frame 13. The so-generated heat affects the capacitor element 11 through the anode wire 12, which damages the capacitor element 11 with thermal-vulnerable property.

Such a thermal shock, which is applied to the capacitor element 11, destructs a dielectric substance, leading to deterioration in product features or causing product defects, which in turn increases the production cost of the solid electrolytic capacitor.

### SUMMARY OF THE INVENTION

The present invention has been invented in order to overcome the above-described problems and it is, therefore, an object of the present invention to provide a solid electrolytic capacitor and a manufacturing method thereof, in which an oxidation-resistant coating layer configured to surround the surface of a terminal reinforcing material underlies a capacitor element, thereby preventing the surface of the terminal reinforcing material from being oxidized while the capacitor is produced inside a high temperature chamber.

In accordance with one aspect of the present invention to achieve the object, there is provided a solid electrolytic capacitor, comprising: a capacitor element having a positive polarity internally and having one end to which an anode wire is inserted; a cathode leading-out layer having one side formed on one side of the outer surface of the capacitor element; a pair of terminal reinforcing materials configured to be coupled with both sides of the bottom of the capacitor element; an oxidation resistant coating layer configured to surround the surface of the pair of terminal reinforcing materials; a mold part configured to surround the outer periphery of the capacitor element, while exposing the other end of the anode wire, the other side of the cathode leading-out layer, and the lower surfaces of the pair of terminal reinforcing materials; and anode and cathode terminals formed on both sides of the mold part and the lower surfaces of the terminal reinforcing materials by a plating layer.

A cathode layer is further formed on the outer surface of the capacitor element. A conductive shock-absorbing material is formed between the outer surface of the capacitor element on which the cathode layer is formed and the cathode leading-out layer.

A liquid epoxy resin (EMC: Epoxy Molding Compound) underlies the capacitor element. The oxidation resistant coating layer surrounds the surface of the terminal reinforcing materials extends to the lower surface of the liquid epoxy resin.

The terminal reinforcing materials are made of a metal material or a synthetic resin. The metal material includes any one of steel, Cu and Ni.

Preferably, the terminal reinforcing materials may be formed with a thickness of 100 micrometers or lower. In order to obtain the capacitor element having an optimal volume efficiency within a restricted space, the terminal reinforcing materials may be preferably formed with a thickness of 20 to 50 micrometers.

The oxidation-resistant coating layer is coated on the total of four surfaces except exposed surfaces of the terminal reinforcing materials formed in a rectangular parallelepiped shape. Also, the oxidation resistant coating layer extends to the lower surface of the liquid epoxy resin, which is exposed outside from the internal surface of the terminal reinforcing materials. In this arrangement, when the capacitor is produced inside a high temperature chamber, the oxidization of the terminal reinforcing materials id prevented. This further enhances a bonding strength between the terminal reinforcing materials and the liquid epoxy resin.

The mold part is formed on the outer surface of the capacitor element except the lower surface of the capacitor element and the lower surfaces of the terminal reinforcing materials. In the mold part, the other end of the anode wire and the other side of the cathode leading-out layer are exposed.

The capacitor element includes a cathode layer and a cathode reinforcing layer formed the outer surface thereof. The cathode layer includes an insulating layer having an oxidized coated film made of Tantalum oxide (Ta₂O₅), and a solid electrolytic layer made of manganese dioxide (MnO₂). The cathode reinforcing layer includes a carbon layer and a silver (Ag) paste layer which are sequentially formed on the outer periphery of the cathode layer.

The cathode leading-out layer is formed by any one of a dispensing type, a dipping type and a printing type. The cathode leading-out layer is made of a viscous conductive paste.

The anode terminal and the cathode terminal are formed on both sides of the mold part and the lower surfaces of the terminal reinforcing materials by a plating layer, respectively.

The anode terminal and the cathode terminal may be formed by an electrolytic plating, an non-electrolytic plating, or a dipping, or a paste coating.

If the plating layer is formed by the non-electrolytic plating, the plating layer may include an internal plating layer formed by non-electrolytic nickel phosphorus (Ni/P) plating, and an external plating layer formed by plating Cu or Sn on the internal plating layer.

In accordance with another aspect of the present invention to achieve the object, there is provided a method of manufacturing a solid electrolytic capacitor, comprising: forming a pair of terminal reinforcing materials on a film-shaped sheet made of a synthetic resin; forming an oxidation resistant coating layer on the upper surface of the sheet and the upper surface of the pair of terminal reinforcing materials; coating a liquid epoxy resin (EMC) on the oxidation resistant coating layer; preparing a capacitor element having a positive polarity internally and having one end to which an anode wire is inserted, wherein a cathode layer is formed on the capacitor element; forming a cathode leading-out layer on the other side of the capacitor element; arranging the capacitor element on the sheet on which liquid epoxy resin is coated at regular intervals; forming a mold part on the outer periphery of the so-arranged capacitor element; cutting the mold part to expose one side of the cathode leading-out layer and one end of the anode wire from both sides of the mold part; and forming anode and cathode terminals on the both sides of the mold part by a plating layer.

Before the forming the cathode leading-out layer on the other side of the capacitor element, the method further comprises forming a conductive shock-absorbing layer between the cathode reinforcing layer and the cathode leading-out.

The cathode leading-out layer is formed by any one of a dispensing type, a dipping type and a printing type, wherein the cathode leading-out layer is made of a viscous conductive paste.

After the cutting, the method further comprises removing the sheet.

The terminal reinforcing materials are formed by any one of etch-based patterning, electrolytic plating and non-electrolytic plating.

The oxidation resistant coating layer is made of an epoxy series with a good heat resistance, a good chemical resistance, and a good adhesion to the terminal reinforcing materials, wherein the oxidation resistant coating layer is formed by a screen printing or a spray printing.

After the cutting, the method further comprises performing a grinding and trimming on the capacitor element to remove impurity on the cut surface.

The anode terminal and the cathode terminal may be formed by an electrolytic plating, an non-electrolytic plating, or a dipping, or a paste coating.

As described above, in accordance with the present invention, it is possible to make the structure and process of the solid electrolytic capacitor simpler to achieve a reduction in the manufacturing coat. Further, it is possible to form an oxidation resistant coating layer on the surface except the lower surfaces of terminal reinforcing materials, thereby preventing the surfaces of the terminal reinforcing materials from being oxidized during the manufacture of the capacitor. Furthermore, it is possible to reduce deterioration in bonding strength between the terminal reinforcing materials and a liquid epoxy resin.

Further, in accordance with the present invention, it is possible to achieve miniaturization of a solid electrolytic capacitor and also maximize an electrostatic capacitance of the solid electrolytic capacitor.

Moreover, in accordance with the present invention, it is possible to produce a solid electrolytic capacitor having a low ESR (Equivalent Series Resistance) characteristic.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 and 2 are a perspective view and a sectional view of a solid electrolytic capacitor according to the related art, respectively;

FIG. 3 is a sectional view of a solid electrolytic capacitor in accordance with one embodiment of the present invention;

FIG. 4 is a side sectional view of a solid electrolytic capacitor in accordance with one embodiment of the present invention;

FIG. 5 is a sectional view of a capacitor element to be employed in the present invention;

FIG. 6 is a sectional view of the terminal reinforcing material according to present invention;

FIG. 7 is a sectional view of the oxidation-resistant coating layer formed on the upper surface of the terminal reinforcing materials;

FIG. 8 is a sectional view showing coating of the liquid epoxy resin on the capacitor element;

FIG. 9 is a sectional view showing mounting of the terminal reinforcing materials on the capacitor element; and

FIG. 10 is a sectional view showing formation of the mold part on the outer surface of the capacitor element.

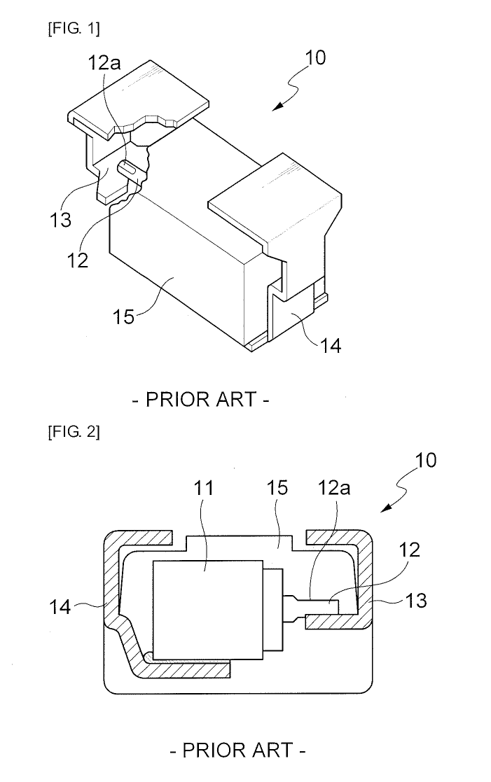

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical sprit of the present invention should be defined by the appended claims, and the following embodiments are merely examples for efficiently describing the technical spirit of the present invention to those skilled in the art.

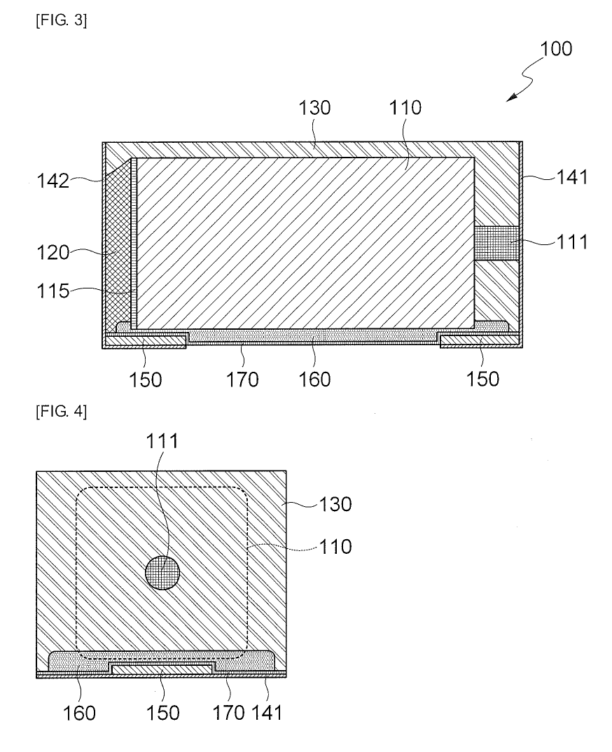

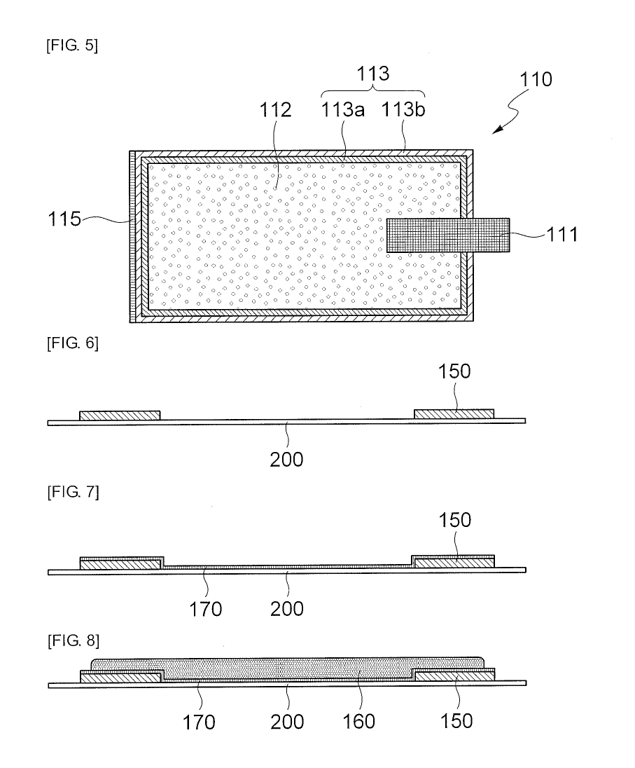

FIG. 3 is a sectional view of a solid electrolytic capacitor in accordance with one embodiment of the present invention. FIG. 4 is a side sectional view of a solid electrolytic capacitor in accordance with one embodiment of the present invention. FIG. 5 is a sectional view of a capacitor element to be employed in the present invention.

As shown in FIGS. 3 to 5, a solid electrolytic capacitor 100 according to one embodiment of the present invention includes a capacitor element 110 coupled with an anode wire 111 at one side thereof, a cathode leading-out layer 120 formed on the other side of the capacitor element 110, a pair of terminal reinforcing materials 150 attached at both ends of the bottom of the capacitor element 110, an oxidation-resistant coating layer 170 formed on the terminal reinforcing materials 150, a mold part 130 surrounding the outer periphery of the capacitor element 110, and an cathode and cathode terminals 141 and 142 formed on both sides of the mold part 130.

The lower surface of the capacitor element 110 interposed between the anode terminal 141 and the cathode terminal 142 is filled with a liquid epoxy resin (EMC) 160. The liquid epoxy resin 160 is interposed between the capacitor element 11° and the terminal reinforcing materials 150, which achieves bonding therebetween.

The oxidation-resistant coating layer 170, which is formed on the terminal reinforcing materials 150, is also formed on the lower surface of the liquid epoxy resin 160. Specifically, the oxidation-resistant coating layer 170 is formed to surround the total of four surfaces including the upper and side surfaces (excepting the lower surfaces) of the terminal reinforcing materials 150, and further surround the lower surface of the liquid epoxy resin 160 formed between the terminal reinforcing materials 150.

In this arrangement, the oxidation-resistant coating layer 170 allows a high temperature of heat to release outside through a gap between the terminal reinforcing materials 150 and the liquid epoxy resin 160, wherein the heat is generated while the capacitor is produced inside a high temperature chamber. Resultantly, the oxidation of the terminal reinforcing materials 150 is prevented. Further, the oxidation-resistant coating layer 170 plays the role of further enhancing a bonding strength between the terminal reinforcing materials 150 and the liquid epoxy resin 160.

Preferably, the oxidation-resistant coating layer 170 may be formed of a material with, for example, a good heat resistance, a good chemical resistance, and a good adhesion to the terminal reinforcing materials 150. More preferably, the oxidation-resistant coating layer 170 may be formed of a material of epoxy series.

In the following, a detailed description will be made as to respective components contained in the solid electrolytic capacitor 100 with the configuration as described above. The capacitor element 110 is formed in a rectangular parallelepiped shape and has one side at which one end of the anode wire 111 is exposed. The other end of the anode wire 111 is electrically connected to the anode terminal 141.

As shown in FIG. 5, the capacitor element 110 includes a tantalum pellet 112 having a positive polarity and including a cathode layer (not shown) formed on its outer surface, and a cathode reinforcing layer 113 including a carbon 113a and a silver paste 113b which are sequentially coated on the outer surface of the cathode layer.

The tantalum pellet 112 is insulated from the cathode layer by an insulating layer made of a dielectric oxide film. The insulating layer is formed by causing a growth of an oxide film (Ta₂O₅) on the tantalum pellet 112 under a chemical conversion process using an electrochemical reaction.

At this time, the insulating layer allows the tantalum pellet 112 to function as a dielectric substance.

The tantalum pellet 112 is made from a mixture of a tantalum power and a binder. Specifically, the tantalum pellet 112 is made by mixing and stirring the tantalum power and the binder by a constant fraction, compressing the so-mixed power in a rectangular parallelepiped shape, and sintering the so-compressed power under a high temperature and a high vibration.

The tantalum pellet 112 may be made of, for example, niobium (Nb) other than tantalum (Ta).

The cathode layer is formed by impregnating the tantalum pellet 112 formed by the insulating layer into the manganese nitrate solution so that the outer surface of the tantalum pellet 112 is coated with the solution, followed by burning the so-coated tantalum pellet 112, and followed by forming the manganese dioxide (MnO₂) having a negative polarity.

In the configuration of the capacitor element 110, the insulating layer and the cathode layer are well known in the art and thus will not be further described.

As described above, the cathode reinforcing layer 113 including the carbon 113a and the silver paste 113b sequentially laminated is formed on the outer surface of the cathode layer. The cathode reinforcing layer 113 is used to improve a conductivity of the cathode of the cathode layer. This facilitates an electrical connection between the cathode reinforcing layer 113 and the cathode leading-out layer 120, which permits polarity conduction.

The cathode leading-out layer 120 is formed on the other side of the capacitor element 110, i.e., a side opposite to the one side to which the anode wire 111 is connected, wherein the cathode reinforcing layer 113 is formed on the outer surface of the capacitor element 110. In this arrangement, the cathode terminal can be stably drawn in a state where the cathode layer is connected with the cathode leading-out layer 120.

Preferably, the cathode leading-out layer 120 may be made of a viscous conductive paste such as Au, Pd, Ag, Ni, Cu, or the like. Further, the cathode leading-out layer 120 is coated on one side of the capacitor element 110, and then is subjected to subsequent processes such as drying, hardening, burning, or the like, thereby achieving a sufficient strength and hardness.

The cathode leading-out layer 120 is harden at a temperature ranging from 30° C. to 300° C. Further, the cathode leading-out layer 120 may be formed by various types, for example, dispensing on the one side of the capacitor element 110 to which the anode wire 111 is connected, dipping of attaching paste on the one side of the cathode leading-out layer 120, printing the paste on the sheet and attaching the same on the one side of the cathode leading-out layer 120, or the like.

Meanwhile, a conductive shock-absorbing layer 115 is formed between the cathode leading-out layer 120 and the cathode reinforcing layer 113 in the one side of the capacitor element 110. The conductive shock-absorbing layer 115 serves to protect the surface of the capacitor element 110 on which the cathode leading-out layer 120 is formed, from the exterior environment.

The conductive shock-absorbing layer 115 may be preferably formed of an epoxy series with a good chemical-mechanical affinity so that the cathode leading-out layer 120 made of the viscous conductive paste is easily attached on the silver paste layer 113b constituting the outermost layer of the cathode reinforcing layer 113.

The reason why the conductive shock-absorbing layer 115 is formed between the cathode reinforcing layer 113 and the cathode leading-out layer 120 is to reduce a contact trouble which is caused by a direct connection between the silver paste layer 113b and the conductive paste formed on the cathode leading-out layer 120.

The conductive shock-absorbing layer 115 may be formed by a lead frame made of steel or a paste material, in place of the conductive epoxy series.

As described above, the terminal reinforcing materials 150 is provided on the both sides of the bottom of the capacitor element 110.

The terminal reinforcing materials 150 is provided at the bottom of the capacitor element 110 in portions at which the anode terminal 141 and the cathode terminal 142 formed on the outer surface of the mold part 130 are formed. Further, the liquid epoxy resin 160 (i.e., liquid EMC) is formed at an interface between the terminal reinforcing materials 150 and the capacitor element 110. This allows the terminal reinforcing materials 150 to be tightly coupled with the capacitor element 110.

In this arrangement, the surfaces of the terminal reinforcing materials 150 are oxidized in a state where the terminal reinforcing materials 150 are coupled with the liquid epoxy resin 160, under various processes such as a high temperature and a high pressure. To address such an oxidation, the oxidation-resistant coating layer 170 is further formed on the surfaces of the terminal reinforcing materials 150.

Similar to the liquid epoxy resin 160, the oxidation-resistant coating layer 170 may be formed by electrolytic plating or non-electrolytic plating. The oxidation-resistant coating layer oxidation resistant coating layer 170 prevents the surfaces of the terminal reinforcing materials 150 from being oxidized, thereby further improving the bonding strength between the terminal reinforcing materials 150 and the liquid epoxy resin 160.

During the manufacturing processes of the solid electrolytic capacitor according to the present invention, a testing equipment is used for a voltage application and a characteristic inspection as needed. A thermal shock is generated while a probe mounted on the testing equipment contacts with the anode terminal 141 and the cathode terminal 142. The terminal reinforcing materials 150 provided on the portions at which the terminals 141 and 142 are formed, absorbs the thermal shock, thereby avoiding a floating or breakage of the terminals 141 and 142.

The terminal reinforcing materials 150 may be made of a metal material, a synthetic resin, a ceramic or the like, which have strength of a predetermined level or higher. The metal material may include a conductive material such as Steel, Cu, Ni or the like.

Further, the terminal reinforcing materials 150 may be formed with a thickness of 100 micrometers or lower. In order to obtain the capacitor element 110 having optimal volume efficiency within a restricted space, the terminal reinforcing materials 150 may be preferably formed with a thickness of 20 to 50 micrometers.

In the provision of the epoxy case 15 at the bottom of the capacitor element 110, a medium to be employed in the provision may be configured by the liquid epoxy resin 160 and the oxidation-resistant coating layer 170 which are filled between the terminal reinforcing materials 150.

The liquid epoxy resin 160 plays the role of surrounding the bottom of the capacitor element 110 to protect the capacitor element 110. In addition, the liquid epoxy resin 160 is formed at the interface between the capacitor element 110 and the terminal reinforcing materials 150, which allows the terminal reinforcing materials 150 to be tightly fixed on the bottom of the capacitor element 110.

The liquid epoxy resin 160 is formed of an insulating material, which allows the terminal reinforcing materials 150 to be insulated from the capacitor element 110 and the cathode terminal 142, thereby preventing a short therebetween.

Typically, a liquid epoxy resin contains a constant amount of release agent. If such a release agent is contained in the liquid epoxy resin 160 to be applied to the embodiment according to the present invention, it degrades the bonding strength between the capacitor element 110 and the terminal reinforcing materials 150. Therefore, in the present invention, the use of the liquid epoxy resin 160 exclusive of the release agent improves the bonding strength between the capacitor element 110 and the terminal reinforcing materials 150.

As described above, in accordance with the present invention, the oxidation-resistant coating layer 170 is formed to surround the lower surface of the liquid epoxy resin 160 while surrounding the total of four surfaces including the upper surfaces and the lateral surfaces of the terminal reinforcing materials 150. This further improves the bonding strength between the terminal reinforcing materials 150 and the liquid epoxy resin 160.

In addition to the mold part 130 surrounding the upper surface of the capacitor element 110, the liquid epoxy resin 160 is filled in the lower surface of the capacitor element 110 to surround the outer surface of the capacitor element 110. The reason for this is that, if the lower surface of the capacitor element 110 is molded with the epoxy material forming the mold part 130, it may occur an unfilled area thereon, which causes a molding defect. Using to address such a problem is the liquid epoxy resin 160 where the epoxy material contains a relatively small size of filler.

Specifically, in accordance with the present invention, the mold part 130 constituting the exterior of the capacitor element 110 is formed of the epoxy material with a filler content of 60 to 90%, wherein the filler is in the range of 50 to 100 micrometers in size. In the formation of the mold part 130 based on the epoxy resin as described above, coating the epoxy resin on the lower surface of the capacitor element 110 causes an unfilled area on the lower surface of the capacitor element 110 depending on the size of the filler.

Accordingly, the liquid epoxy resin 160 with a filler content of 50 to 90%, the filler having a size ranging from 20 to 30 micrometers, is filled in the lower surface of the capacitor element 110. This reduces the unfilled area depending on the size of the filler.

After the liquid epoxy resin 160 is coated and harden on the lower surface of the capacitor element 110, the mold part 130 is formed to surround the outer surface of the capacitor element 110.

Specifically, the mold part 130 surrounds portions except an end surface of the anode wire 111 (which is exposed at the both sides of the capacitor element 110) and an end surface of the cathode leading-out layer 120 and except the lower surface of the capacitor element 110. As a result, it is possible to protect the capacitor element 110 from the external environment. The mold part 130 may be primarily formed of the epoxy material.

The mold part 130 may be formed with epoxy for respective capacitor elements, and may be formed in a batch manner after arranging a plurality of capacitor elements at regular intervals.

Thus, the anode terminal 141 and the cathode terminal 142 are formed on the both sides of the mold part 130 through the plating layer, thereby making it possible to produce individual solid electrolytic capacitors.

Although the anode terminal 141 and the cathode terminal 142 have been shown to be formed on the both sides of the mold part 130, it may be formed extending from the both sides of the mold part 130 downward, on ground that the solid electrolytic capacitor is an electronic part based on surface-mount (SMT).

Specifically, as shown in FIG. 3, the anode wire 111 and the cathode leading-out layer 120, which are exposed outside from the both sides of the mold part 130, are electrically connected with the plating layer, to thereby form the anode terminal 141 and the cathode terminal 142. The anode terminal 141 and the cathode terminal 142 are formed extending to the lower surfaces of the pair of terminal reinforcing materials 150.

A portion of the liquid epoxy resin 160 coated on the lower surface of the capacitor element 110 is flown up to the upper surface of the terminal reinforcing material 150. As such, the terminal reinforcing material 150 positioned at the anode terminal 141 is kept to be insulated from the capacitor element 110.

The plating layer, which is used in forming the anode terminal 141 and the cathode terminal 142, may be formed by electrolytic plating or non-electrolytic plating. Further, the plating layer may be formed by a dipping, a paste coating or the like so that the manufacturing cost of the solid electrolytic capacitor 100 is further decreased.

If the plating layer is formed by the non-electrolytic plating, the plating layer may include an internal plating layer formed by non-electrolytic nickel phosphorus (Ni/P) plating, and an external plating layer formed by plating Cu or Sn on the internal plating layer.

In the following, a detailed description will be made as to a manufacturing method of the solid electrolytic capacitor with the configuration as described above with reference to drawings.

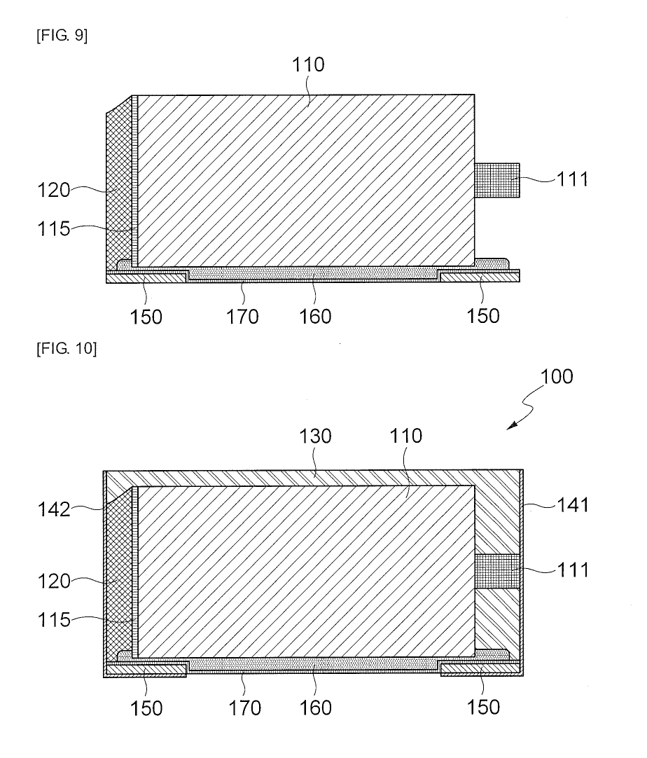

FIG. 6 is a sectional view of the terminal reinforcing material according to present invention. FIG. 7 is a sectional view of the oxidation-resistant coating layer formed on the upper surface of the terminal reinforcing materials. FIG. 8 is a sectional view showing coating of the liquid epoxy resin on the capacitor element. FIG. 9 is a sectional view showing mounting of the terminal reinforcing materials on the capacitor element. FIG. 10 is a sectional view showing formation of the mold part on the outer surface of the capacitor element 110.

First, as shown in FIG. 6, the terminal reinforcing materials 150 are formed on a sheet 200 made of a synthetic resin at regular intervals. Subsequently, as shown in FIG. 7, the oxidation-resistant coating layer 170 is formed to coat the upper surface of the sheet 200 and the terminal reinforcing materials 150.

Subsequently, as shown in FIG. 8, the liquid epoxy resin 160 is coated on the upper surface of the oxidation resistant coating layer 170.

The interval at which the terminal reinforcing materials 150 are formed on the sheet 200 is variable according to the size of the capacitor element 110. Further, the terminal reinforcing materials 150 are formed at a predetermined distance so that both sides of the bottom of the capacitor element 110 can be stably supported by the terminal reinforcing materials 150.

The oxidation-resistant coating layer 170 formed on the terminal reinforcing materials 150 and the sheet 200, may be formed by electrolytic plating or non-electrolytic plating, and may be preferably formed of a material with a good affinity for the liquid epoxy resin 160.

Further, the oxidation-resistant coating layer 170 may be preferably formed of a material (e.g., epoxy material) with a good heat resistance, a good chemical resistance, and a good adhesion to the terminal reinforcing materials 150. Furthermore, the oxidation-resistant coating layer 170 may be formed on four surfaces (i.e., two upper surface and two later surfaces) of the terminal reinforcing materials 150 and the entire upper surface of the sheet 200.

In the manufacturing process of the solid electrolytic capacitor, while the solid electrolytic capacitor is formed inside a high temperature chamber, the oxidation-resistant coating layer 170 prevents the surfaces of the terminal reinforcing materials 150 from being oxidized due to exposure to a high temperature or a chemical agent. This prevents the bonding strength between the terminal reinforcing materials 150 and the liquid epoxy resin 160 from being decreased.

In the coating of the liquid epoxy resin 160 on the oxidation resistant coating layer 170, a portion of the liquid epoxy resin 160 is preferably coated on portions corresponding to the upper surfaces of the terminal reinforcing materials 150. The liquid epoxy resin 160 coated on the terminal reinforcing materials 150 is harden so that the capacitor element 110 formed on the liquid epoxy resin 160 is tightly bonded with the terminal reinforcing materials 150.

Subsequently, the cathode reinforcing layer 113 is formed on the outer periphery of as-prepared capacitor element to produce the capacitor element 110 with a negative polarity at its surface, wherein one end of the anode wire 111 is protruded from one side of the capacitor element 110 and the cathode leading-out layer 120 is formed on the other side of the capacitor element 110.

The cathode leading-out layer 120 formed on the capacitor element 110 may be formed by employing any one of a dispensing type using a nozzle, a dipping type and a printing type, but not limited thereto. For example, any type by which the cathode can be stably drawn from the cathode reinforcing layer 113 may be employed.

The cathode leading-out layer 120 may be preferably formed of a viscous conductive paste such as Au, Pd, Ag, Ni, Cu, or the like. The cathode leading-out layer 120 is coated on the one side of the capacitor element 110 and has a sufficient strength and hardness through the processes such as a drying, a hardening, a sintering or the like at a temperature ranging approximately 30 to 300° C.

Before the cathode leading-out layer 120 is formed on the one side of the capacitor element 110, the conductive shock-absorbing layer 115 is further formed on the one side of the capacitor element 110. The conductive shock-absorbing layer 115 serves to protect the one side of the capacitor element 110 from the exterior environment, and also serves to reduce a contact trouble which is generated at the interface between the cathode leading-out layer 120 and cathode reinforcing layer 113 formed on the capacitor element 110.

Subsequently, the capacitor element 110 in which the anode wire 111 and the cathode leading-out layer 120 are formed, is mounted on the sheet 200 on which the liquid epoxy resin 160 is coated up to the upper surfaces of the terminal reinforcing materials 150.

In this case, both ends of the bottom of the capacitor element 110 are disposed on the two upper surfaces of the terminal reinforcing materials 150. The capacitor element 110 and the terminal reinforcing materials 150 are tightly coupled each other by the liquid epoxy resin 160 interposed therebetween. The liquid epoxy resin 160 coated on the sheet 200 protects the lower surface of the capacitor element 110.

Thus, as shown in FIG. 10, in the capacitor element 110 mounted on the sheet 200 on which the terminal reinforcing materials 150 is formed, the mold part 130 is formed on the outer surface of the capacitor element 110 exclusive of a portion coated with liquid epoxy resin 160, by using an epoxy resin containing a relatively large particle of filler.

The mold part 130 is formed on the outer surface of the capacitor element 110 arranged on the sheet 200 at regular intervals, and the outer periphery of the anode wire 111 and the cathode leading-out layer 120 exposed from the capacitor element 110.

Thereafter, the capacitor element 110 formed on the mold part 130 is sliced to produce unit solid electrolytic capacitor.

The solid electrolytic capacitor 100 with the mold part 130 formed thereon may be sliced by a dicing using a blade, or a laser-based cutting method. A cut surface of the sliced unit solid electrolytic capacitor is subject to grinding or trimming so that an end portion of the anode wire 111 and one surface of the cathode leading-out layer 120 are exposed.

Subsequently, the sheet 200 used in forming the terminal reinforcing materials 150 and the liquid epoxy resin 160 is removed. The sheet 200 may be removed by a thermal, a chemical or a mechanical technique.

The grinding and the trimming on the both sides of the capacitor element 110 remove impurity on a surface on which the plating layer is formed. In the product which has been subjected to the grinding and the trimming, plating process is performed on the both sides of the mold part 130 and the lower surfaces of each of the terminal reinforcing materials 150, thereby forming the anode terminal 141 and the cathode terminal 142.

A coated film formed on the surface of the anode wire 111, which has one end exposed from the mold part 130, is removed through the use of laser. This improves an electric conductivity.

As described above, the plating layer used in forming the anode terminal 141 and the cathode terminal 142 may be formed by electrolytic plating or non-electrolytic plating. Further, the plating layer may be formed by the dipping type or the coating type which uses a paste on the bode sides of the mold part 130.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

What is claimed is:

1. A solid electrolytic capacitor, comprising:
a capacitor element having a positive polarity internally and having one end to which an anode wire is inserted;
a cathode leading-out layer having one side formed on one side of the outer surface of the capacitor element;
a pair of terminal reinforcing materials configured to be coupled with both sides of the bottom of the capacitor element;
an oxidation resistant coating layer configured to surround the surface of the pair of terminal reinforcing materials;
a mold part configured to surround the outer periphery of the capacitor element, while exposing the other end of the anode wire, the other side of the cathode leading-out layer, and the lower surfaces of the pair of terminal reinforcing materials; and
anode and cathode terminals formed on both sides of the mold part and the lower surfaces of the terminal reinforcing materials by a plating layer.

2. The solid electrolytic capacitor according to claim 1, wherein the a cathode layer is further formed on the outer surface of the capacitor element,
wherein a conductive shock-absorbing material is formed between the outer surface of the capacitor element on which the cathode layer is formed and the cathode leading-out layer.

3. The solid electrolytic capacitor according to claim 1, wherein a liquid epoxy resin underlies the capacitor element, wherein the oxidation resistant coating layer surrounding the surface of the terminal reinforcing materials extends to the lower surface of the liquid epoxy resin.

4. The solid electrolytic capacitor according to claim 1, wherein the terminal reinforcing materials are made of a metal material or a synthetic resin, wherein the metal material include any one of steel, Cu and Ni.

5. The solid electrolytic capacitor according to claim 1, wherein the capacitor element includes a cathode layer and a cathode reinforcing layer formed the outer surface thereof,
wherein the cathode layer includes an insulating layer having an oxidized coated film made of Tantalum oxide (Ta₂O₅), and a solid electrolytic layer made of manganese dioxide (MnO₂),
wherein the cathode reinforcing layer includes a carbon layer and a silver (Ag) paste layer which are sequentially formed on the outer periphery of the cathode layer.

6. A method of manufacturing a solid electrolytic capacitor, comprising:
forming a pair of terminal reinforcing materials on a film-shaped sheet made of a synthetic resin;
forming an oxidation resistant coating layer on the upper surface of the sheet and the upper surface of the pair of terminal reinforcing materials;
coating a liquid epoxy resin (EMC) on the oxidation resistant coating layer;
preparing a capacitor element having a positive polarity internally and having one end to which an anode wire is inserted, wherein a cathode layer is formed on the capacitor element;
forming a cathode leading-out layer on the other side of the capacitor element;
arranging the capacitor element on the sheet on which liquid epoxy resin is coated at regular intervals;
forming a mold part on the outer periphery of the so-arranged capacitor element;
cutting the mold part to expose one side of the cathode leading-out layer and one end of the anode wire from both sides of the mold part; and
forming anode and cathode terminals on the both sides of the mold part by a plating layer.

7. The method according to claim 6, further comprising: before the forming the cathode leading-out layer on the other side of the capacitor element, forming a conductive shock-absorbing layer between the cathode reinforcing layer and the cathode leading-out.

8. The method according to claim 7, wherein the cathode leading-out layer is formed by any one of a dispensing type, a dipping type and a printing type, wherein the cathode leading-out layer is made of a viscous conductive paste.

9. The method according to claim 6, further comprising: after the cutting, removing the sheet.

10. The method according to claim 6, wherein the terminal reinforcing materials are formed by any one of etch-based patterning, electrolytic plating and non-electrolytic plating.

11. The method according to claim 6, wherein the oxidation resistant coating layer is made of an epoxy series with a good heat resistance, a good chemical resistance, and a good adhesion to the terminal reinforcing materials, wherein the oxidation resistant coating layer is formed by a screen printing or a spray printing.

12. The method according to claim 6, further comprising: after the cutting, performing a grinding and trimming on the capacitor element to remove impurity on the cut surface.
